(19) United States
(12) Patent Application Publication
(10) Pub. No.: US 2002/0081129 A1
(43) Pub. Date: Jun. 27, 2002

(54) Electrophotographic device

(76) Inventors: Yuuichi Takano, Hitachi (JP); Nobuaki Fukasawa, Hitachi (JP); Satoshi Narita, Hitachiohta (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/972,997

(22) Filed: Oct. 10, 2001

(30) Foreign Application Priority Data
Dec. 21, 2000 (JP) 2000-388058

(51) Int. Cl. G03G 15/00

(52) U.S. Cl. 399/167

(57) ABSTRACT

Rotating speed of a photosensitive body is reduced, when rotating the same for preventing deterioration due to ozone. In that an electrophotographic device which comprises the photosensitive body; a charger which uniformly charges the surface of the photosensitive body; and a motor control unit which performs drive control for a motor which causes to rotate and stop the photosensitive body, wherein the motor control unit includes a plurality of speed levels of a speed level for rotating the photosensitive body during printing and another speed level for rotating the photosensitive body which is reduced lower than the speed during the printing, and is provided with a speed change-over means which changes over the plurality of speed levels depending on the operating condition thereof. Thereby, a deterioration of the photosensitive body due to ozone generated from the changer is prevented and another deterioration of the photosensitive body due to rotation thereof when rotating the same other than printing operation is also prevented.

### BACKGROUND OF THE INVENTION

1. Field of the Invention

The present invention relates to an electrophotographic printer such as a laser beam printer and an electrophotographic device such as an electrophotographic copying machine, and, in particular, relates to an electrophotographic device with a rotation control means for a photosensitive body.

2. Conventional Art

JP-A-8-248844 (1996), for example, discloses an electrophotographic device in which, after turning off a changer, a photosensitive body is rotated for a predetermined time based on the driving time of the charger until the turning off to thereby eliminate deterioration of the photosensitive body due to ozone.

Although JP-A-8-248844 (1996) discloses reducing deterioration of the photosensitive body due to ozone by rotating the same for a predetermined time, however, does not take into account a possible influence of shortening the life time of the photosensitive body by the rotation thereof.

Other than deterioration due to printing beams and due to ozone the life time of the photosensitive body is affected by rotation of itself, in particular, with regard to an electrophotographic device using a belt shaped photosensitive body, if the photosensitive body is rotated additionally, deterioration of the photosensitive body itself is caused. In particular, with regard to a recent electrophotographic device with a higher printing speed the deterioration of the photosensitive body appears remarkably with such measure.

### SUMMARY OF THE INVENTION

An object of the present invention is to provide a method of avoiding deterioration due to rotation of a photosensitive body as well as of preventing deterioration of the photosensitive body and an electrophotographic device main body due to ozone.

In order to achieve the above object, one of features of the electrophotographic device of the present invention is to reduce the rotating speed of the photosensitive body, when rotating the photosensitive body for preventing deterioration thereof due to ozone.

Further, another feature of an electrophotographic device of the present invention which comprises a photosensitive body; a charger which uniformly charges the surface of the photosensitive body; and a motor control unit which performs drive control for a motor which causes to rotate and stop the photosensitive body is characterized in that the motor control unit includes a plurality of speed levels of a speed level for rotating the photosensitive body during printing and another speed level for rotating the photosensitive body which is reduced lower than the speed during the printing, and is provided with a speed change-over means which changes over the plurality of speed levels depending on the operating condition thereof.

### BRIEF DESCRIPTION OF THE DRAWINGS

FIG. 1 is a vertical cross sectional schematic diagram of an entire structure of a color laser beam printer relating to one embodiment of the present invention;

FIG. 2 is a detailed block diagram of a control unit in FIG. 1;

FIG. 3 is a flow chart of a series of operation including processings of avoiding deterioration due to ozone in the color laser beam printer in FIG. 1; and

FIG. 4 is a flow chart of another series of operation including processings of avoiding deterioration due to ozone in the color laser beam printer in FIG. 1.

### DETAILED DESCRIPTION OF PREFERRED EMBODIMENT

Hereinbelow, an embodiment of the present invention will be explained with reference to the drawings.

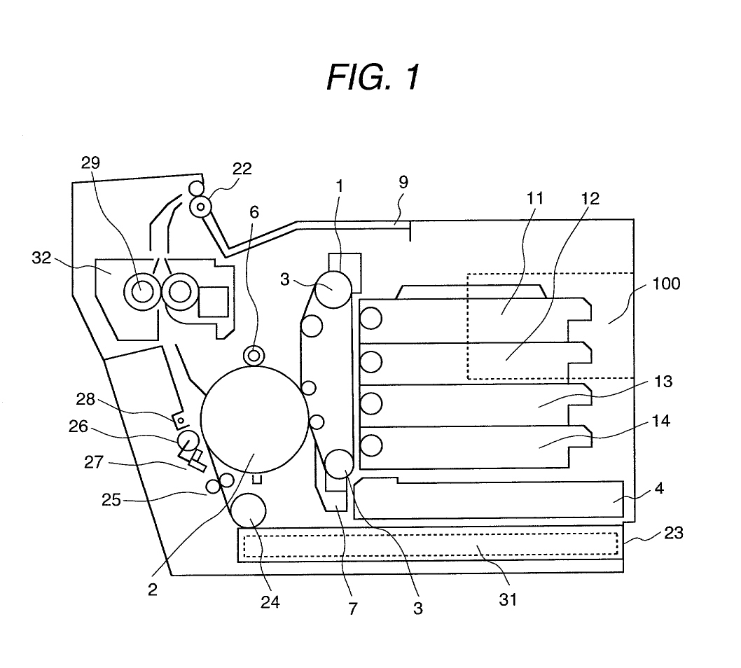

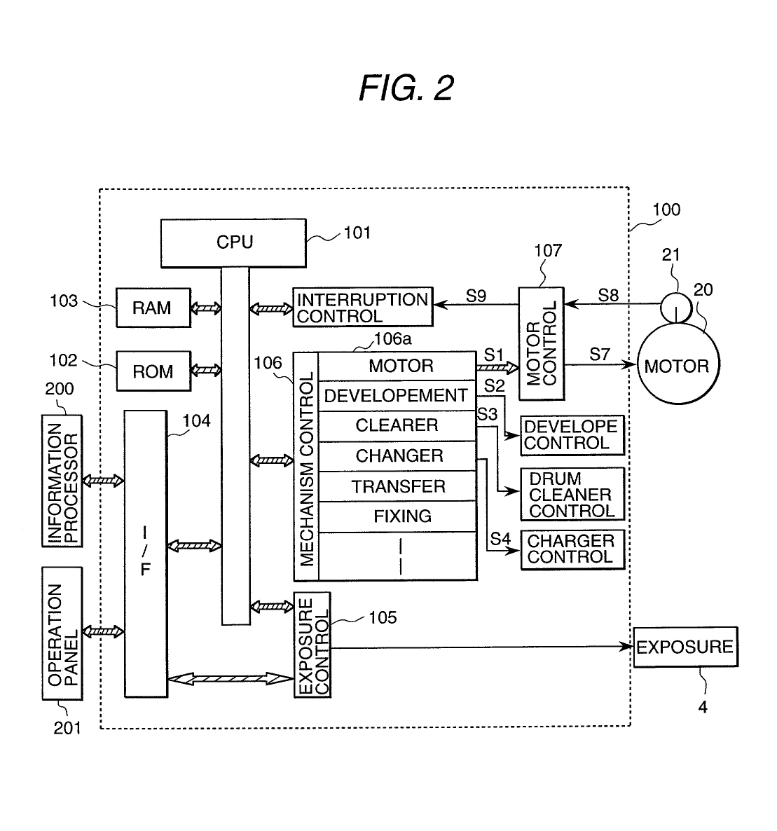

FIG. 1 shows a vertical cross sectional schematic view of an entire structure of a color laser beam printer relating to one embodiment of the present invention, and FIG. 2 shows details of the control unit in FIG. 1.

As shown in FIG. 1, while a photosensitive belt 1 rotates around guide rollers 3 with a predetermined speed, the photosensitive belt 1 is uniformly charged by a charger 7 which generates a high voltage, and is exposed by laser beams not shown emitted from an exposure unit 4 according to image signals of respective colors, forms successively electrostatic latent images corresponding to respective colors and further forms toner images of respective colors by selecting one of developers using a developing agent of a corresponding color among four developers 11, 12, 13 and 14 and by successively developing the electrostatic latent images.

The toner images of respective colors on the surface of the photosensitive belt 1 are transferred in an overlapping manner on the surface of a transfer drum 2 which rotates in synchronism with the photosensitive belt 1 while contacting the surface thereof to thereby form a color toner image on the surface of the transfer drum 2. Paper sheet 31 representing recording medium stored in a paper feeding cassette 23 is extracted and delivered by a paper feeding roller 24 and is sent to a register roller 25 wherein the delivering timing of the paper sheet 31 and the colored toner image on the surface of the transfer drum 2 is controlled so as to match each other, thereafter the paper sheet 31 is delivered toward a transfer roller 26.

Thereafter, while the paper sheet 31 being contacted to the transfer drum 2, the paper sheet 31 is provided from the back face thereof of a mechanical pressing force and of transfer electric field by the transfer roller 26, thereby, the colored toner image on the surface of the transfer drum 2 is transferred on to the paper sheet 31.

Further, during the process of forming the toner images of respective colors of the photosensitive belt 1 on the surface of the transfer drum 2 the transfer roller 26 is prevented activation and is lifted up so as to avoid interference. At the very process of transferring the colored toner image after completing the same, the transfer roller 26 is activated and is pushed out toward the transfer drum 2 by means of a transfer roller contact and separation unit 27.

An AC decharger 28 is supplied with an AC voltage and generates an AC corona, neutralizes electric charges remaining on the back face of the paper sheet 31 on which the colored toner image was transferred and removes the same. The decharging functions to facilitate separation of the paper sheet 31 from the transfer drum 2.

The paper sheet 31 separated from the transfer drum 2 is delivered toward a fixing roller 29. The fixing roller 29 constitutes a part of a fixing unit 32 and when passing the delivered paper sheet 31 through the fixing roller 29, the colored toner image is thermally fixed on the surface of the paper sheet 31. The paper sheet 31 on which the colored toner image has been thermally fixed is discharged on a paper discharge tray 9 via a paper discharge roller 30.

A drum cleaner 6 cleans toner remaining on the surface of the transfer drum 2. Further, during the process in which a color toner image is formed by repeating the transfer of single color toner images on the surface of the transfer drum 2, the drum cleaner 6 is lifted up to deactivate the cleaning operation, and after completing transference of the colored toner image onto the paper sheet 31, the drum cleaner 6 is pressed on the surface of the transfer drum 2 to active the same.

A control unit 100 controls the above explained respective constituting means depending on input signals from an operation panel and input signals from an information processing unit 200 which will be explained later.

In FIG. 2, the control unit 100 is primarily constituted by a central processing unit (hereinbelow, abbreviated as CPU) 101, a ROM 102 which stores control programs for the CPU 101 and a work memory RAM 103 which is necessary when the CPU executes the control programs.

An input and output interface (I/F) 104 is to interface when the CPU 101 communicates with such as the operation panel and an information processing unit such as a personal computer, and transmits printing data generated by the information processing unit 200 to an exposure control unit 105, which controls the exposure unit 4 to cause to generate laser beams 10.

A mechanism control unit 106 is a group of control portions which control a group of mechanisms in the process of electrophotographing, and, through control by the CPU 101, outputs a motor drive command signal S1, a developer drive command signal S2, a drum cleaner drive command signal S3 and a charger drive command signal S4, and, in addition, performs signal input and output for controlling such as a transfer portion 106e and a fixing portion 106f.

A motor control unit 107 is connected so as to control a motor 20 which drives such as the photosensitive belt 1, the paper feeding roller 24 and the fixing roller 29, generates a drive signal S7 according to the motor drive command signal S1 provided from a motor portion 106a and receives a detection signal S8 of an angular displacement amount generated from an encoder 21 directly coupled to a rotary shaft of the motor 20. Further, the motor control unit 107 transmits the detection signal S8 from the encoder 21 as a rotation angle signal S9 for the photosensitive belt 1 to the CPU 101 via an interruption control unit 108.

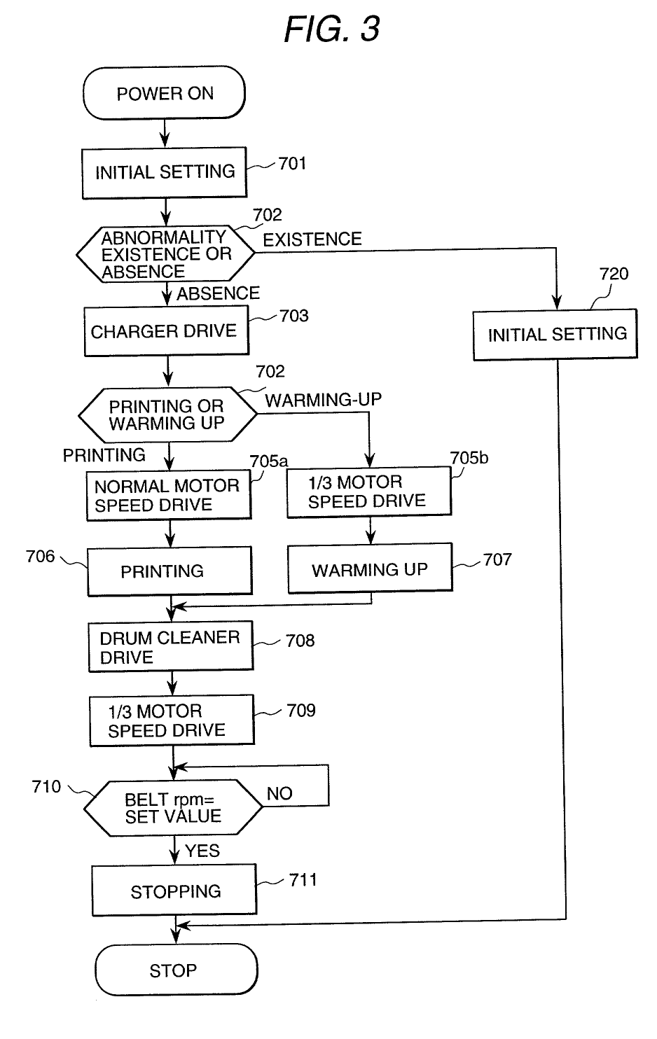

A series of operations of the color laser beam printer with the above explained constitution including processing of avoiding deterioration due to ozone will be explained with reference to a flow chart as shown in FIG. 3.

The processing of avoiding deterioration due to ozone is started after the power source of the main body is turned on.

When the power source is made, the CPU 101 performs initialization for I/Oₛ of control objects and for the interface control unit with the information processing unit 200 (step 701), and the CPU 101 monitors whether or not abnormality exists within the printer (step 702). If an abnormality is detected, the process branches to an abnormality countermeasuring processing which depends on the detected abnormality content (step 720).

When no abnormality exists within the printer, the CPU 101 executes to turn on the charging (step 703). In step 703, the changer drive command signal S4 is outputted from the charger portion 106d to drive the charger 7. At this moment, ozone is generated near the changer 7.

In this moment, when the photosensitive belt 1 is in a stopped state, the photosensitive belt 1 located immediately above the changer 7 is to be exposed to the ozone at the corresponding portion. Therefore, the motor drive command signal S1 is outputted to the motor control unit 107 to drive the motor 20. Through the rotation of the motor 20 the photosensitive belt 1 is rotated so that the exposure of the same portion of the photosensitive belt 1 to the ozone generated near the charger 7 is prevented.

Subsequently, at step 704 the CPU 101 discriminates kinds of drive processings in a series of operating conditions of the electrophotographic device such as printing process and warming-up.

In the present embodiment, the drive processings will be explained with reference to the printing process and warming-up.

At first, in a case of the printing process the processing branches to step 705a, and in a case of the warming-up the processing branches to step 705b.

The steps 705a and 705b are processings in which the motor drive command signal S1 is changed over depending on the kinds of drive processings. In the present embodiment, the motor drive command signal S1 includes four levels of normal speed drive command S11, ½ speed drive command S12, ⅓ speed drive command S13 and stop command S10. The motor control unit 107 changes over the drive speed of the motor 20 depending on the outputted level of the motor drive command signal S1 and drives the motor 20 according to the speed commanded by the CPU 101. Thereby, the photosensitive belt 1 driven by the motor 20 is driven at the commanded speed.

The CPU 101 changes over the level of the motor drive command signal S1 depending on the kinds of the drive processings.

The step 705a is a processing of outputting the motor drive command signal S1 for the printing process and the normal speed drive command S11 is output.

The step 705b is a processing of outputting the motor drive command signal S1 for the warming up process and the ⅓ speed drive command S13 is output.

As has been explained, through the change-over of the motor drive command signal S1 depending on the kinds of processings the drive speed of the photosensitive belt 1 can be changed over.

In the case of printing process, the CPU 101 executes the printing process at step 706 and in the case of warming up process the CPU 101 executes the warming up process at step 707.

After completing the processing at step 706 or step 707, the processing moves to the drum cleaner drive process at step 708.

At step 708, the drum cleaner drive is carried out.

The drum cleaner drive signal S3 is outputted from the cleaner portion 106c to the drum cleaner control unit 109 to drive the drum cleaner 6. Thereby, the toner deposited onto the transfer drum 2 is removed. The signal level of the motor drive command signal S1 at this moment is hold at what is set at step 705a or 705b.

Further, since it is unnecessary to drive the changer 7, the changing is turned off. Thus no ozone is generated from now on, it is unnecessary to take measure for exhausting the ozone remaining in the machine.

For the drum cleaner drive at step 708, it is necessary to rotate the drum cleaner 6 more than one rotation in order to remove all of the toner on the transfer drum 2, the rotation amount of the drum cleaner 6 is set at two rotations.

Subsequently, when the level of the motor drive command signal S1 is at the normal speed drive command S11 at step 709, the level is changed over to the ⅓ speed drive command S13, and when the level is at the ⅓ speed drive command, the level is hold as it is. After completing the processing at step 709, the processing moves to a standby process at step 710.

In the standby process, a rotation amount necessary for the photosensitive belt 1 and the output time of the motor drive command signal S1 are calculated depending on the kinds of processings at step 704. This is because the amount of ozone generated differs depending on the drive time of the changer 7, for example, when the printing process is performed continuously or when a warming up process is performed, the drive time of the changer 7 is long, therefore, the output time of the motor drive command signal S1 is set longer, on the other hand, such as when printing process of a single sheet is performed, the drive time of the changer 7 is short, therefore, the output time of the motor drive command signal S1 is set shorter.

In the present embodiment, the output time of the motor drive command signal S1 is set by converting into rotation number of the photosensitive belt 1. For example, when setting the output time long, the rotation number of the photosensitive belt 1 is set at six times and when setting the same short, the rotation number of the photosensitive belt 1 is set at 0 time. The set values in the present embodiment is determined by the time required to exhaust the ozone within the machine by an ozone exhausting fan not shown.

With the above process, when operations other than the printing process are performed, the speed of the photosensitive belt 1 assumes ⅓ of the normal speed, therefore, if the photosensitive belt 1 is driven for the same time as in the normal speed, the rotation amount of the photosensitive belt 1 assumes ⅓ in the normal speed.

Thereafter, the machine stands by until the calculated drive time has passed.

When the output time is set short, since the rotation number of the photosensitive belt 1 is set at 0 time, the processing immediately moves to the stopping process of step 711.

At step 711, the CPU 101 commands stops to the respective driven mechanism control portions, causes to stop the operation thereof and shifts to a standby condition which permits subsequent printing operation.

As has been explained above, since the level of the motor drive command signal S1 is changed over depending on the kinds of the drive processings to perform a variety of processings, the drive speed of the photosensitive belt 1 is changed over, thereby, deterioration of the photosensitive belt 1 due to rotation thereof can be prevented.

Another advantage of the present invention is that since the motor 20 is to drive at the same time the fixing roller 29 in the fixing unit 32, the rotating speed of the fixing roller 29 is low in synchronism with the speed of the photosensitive belt 1, thereby, the influence of the fixing unit 32 with regard to the life time of the machine also reduced.

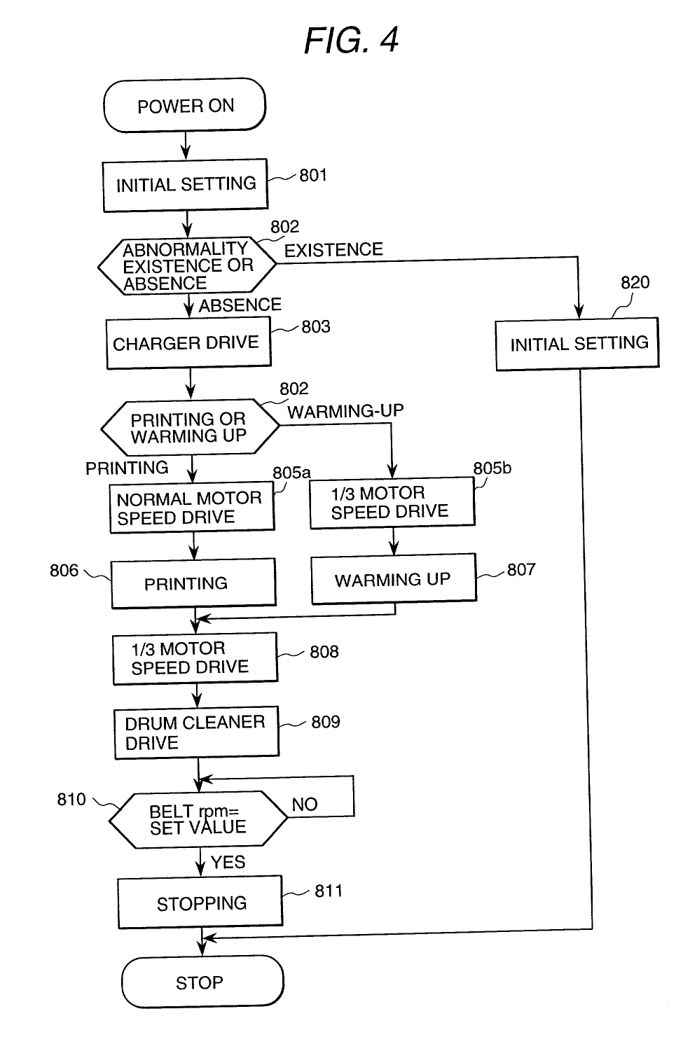

Another embodiment of the present invention will be explained with reference to a flow chart as shown in FIG. 4.

In the present embodiment, processings from step 801 to step 806 or to step 807 are performed like those in FIG. 3 embodiment.

Prior to the drum cleaning process at step 809, the motor speed changing process at step 808 is performed, thereby, the speed of the photosensitive belt 1 can be reduced ⅓ during the drum cleaning process, which can further prevent deterioration of the photosensitive belt 1 due to rotation thereof.

According to the present embodiment, an electrophotographic device which meets both requirements to prevent deterioration of the photosensitive belt 1 due to rotation through performing a variety of processings by changing over the motor drive command signal S1 depending on the kinds of the drive processings and to respond to intermittent printing requirement can be provided.

According to the present invention, through speed reduction of the rotating speed of the photosensitive body and the rotating speed of the fixing roller other than the printing operation, an advantage, that the deterioration of the photosensitive body and the fixing roller due to rotation thereof is prevented and at the same time the deterioration of the photosensitive body and the electrophotographic device due to ozone can be prevented, can be achieved.

1. An electrophotographic device which comprises a photosensitive body; a charger which uniformly charges the surface of the photosensitive body; and a motor control unit which performs drive control for a motor which causes to rotate and stop the photosensitive body, characterized in that the motor control unit includes a plurality of speed levels of a speed level for rotating the photosensitive body during printing and speed levels for rotating the photosensitive body which are reduced lower than the speed during the printing and include a speed for a processing of avoiding deterioration thereof due to ozone, and is provided with a speed change-over means which changes over the plurality of speed levels depending on the operating condition thereof.

2. An electrophotographic device which comprises a photosensitive body; a charger which uniformly charges the surface of the photosensitive body; and a motor control unit which performs drive control for a motor which causes to rotate and stop the photosensitive body, characterized in that the motor control unit reduces the rotating speed of the photosensitive body when rotating the same for other than a printing operation lower than the rotating speed thereof when performing the printing operation so as to perform a processing of avoiding deterioration of the photosensitive body due to ozone.

3. An electrophotographic device of claim 2, characterized in that when rotating the photosensitive body after completing the printing operation, the photosensitive body is rotated more than one rotation at the rotating speed during the printing operation, thereafter, the rotating speed of the photosensitive body is reduced.

4. An electrophotographic device which comprises a photosensitive body; a charger which uniformly changes the surface of the photosensitive body; a fixing unit which causes to pass a non fixed toner image held on the surface of a recording paper between two facing rollers of a heating roller and a pressing roller and to melt and fix the toner image on the recording paper by heating and pressing; and a motor control unit which performs drive control of a motor for rotating and stopping the photosensitive body and the heating roller and the pressing roller in the fixing unit, characterized in that the motor control unit reduces the rotating speed of the photosensitive body and the heating roller and the pressing roller in the fixing unit when rotating the same for other than printing operation lower than the rotating speed thereof when performing the printing operation.
